(19) United States
(12) Patent Application Publication
(10) Pub. No.: US 2025/0175764 A1
(43) Pub. Date: May 29, 2025

(54) Zone Ambiguity Condition Identification and Mitigation

(71) Applicant: ZEBRA TECHNOLOGIES CORPORATION, Lincolnshire, IL (US)

(72) Inventors: Charles Burton Swope, Coral Springs, FL (US); Stanko Jelavic, Davie, FL (US)

(21) Appl. No.: 18/523,475

(22) Filed: Nov. 29, 2023

(51) Int. Cl. H04W 4/029; G01S 13/87; G06K 7/10

(52) U.S. Cl. CPC H04W 4/029; G01S 13/878; G06K 7/10366

(57) ABSTRACT

Zone Ambiguity condition reduction is provided via tracking a location of a tag among a plurality of zones in a defined space via signals transmitted by the tag that are received by one or more anchors of a plurality of anchors, wherein each anchor of the plurality of anchors is associated with a single corresponding zone of the plurality of zones, and the tag is tracked as being located in no more than one zone of the plurality of zones at any given time; identifying that the tag exhibits a zone ambiguity condition; and modifying, in response to identifying the tag as exhibiting the zone ambiguity condition, a transmission power of the signals used to track the location of the tag until the tag no longer exhibits the zone ambiguity condition.

### BACKGROUND

Real-time location systems are designed for monitoring and tracking objects and individuals in a defined space and can utilize various technologies including Wi-Fi, Bluetooth, and Ultra-Wideband (UWB). Many applications have adopted real-time location systems including, but not limited to, tracking patients in a hospital, monitoring children in a daycare facility, and locating shipments in a transportation facility. Locating objects and individuals with a minimum latency is highly desirable to provide real-time and accurate locationing. For example, for a time-critical application, such as tracking patients in a hospital, providing prompt aid to patients is critical. In some scenarios, such as when a tracked object/person is travelling from one zone to another zone or is situated proximate to a border of multiple zones in the defined space, a zone ambiguity condition may occur in which the object/person is located in different zones alternatingly so that a final location cannot be accurately determined. A perpetual zone ambiguity condition can necessitate an intervention from a supervisory device or a human being to determine the actual location of the tracked object/person.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of an exemplary arrangement of a real-time location system, according to embodiments of the present disclosure.

FIG. 2 is a diagram illustrating the communications between different components in the location system in a bi-directional configuration, according to embodiments of the present disclosure.

FIG. 3 is a diagram illustrating the communications between different components in the location system in a uni-directional configuration, according to embodiments of the present disclosure.

FIG. 4 is an example timing diagram illustrating a zone ambiguity condition, according to embodiments of the present disclosure.

FIG. 5 is a flowchart of an example method of locating an object or an individual wearing a tag in a bi-directional configuration, according to embodiments of the present disclosure.

FIG. 6 is a flowchart of an example method of locating an object or an individual wearing a tag in a uni-directional configuration, according to embodiments of the present disclosure.

FIG. 7 illustrates a formulation of an example history queue and a conversion from the example history queue to an example weighted queue, according to embodiments of the present disclosure.

FIG. 8 is a flowchart of an example method of detecting and handling a zone ambiguity condition, according to embodiments of the present disclosure.

FIG. 9 is a flowchart of an example method for Zone Ambiguity Condition Identification and Mitigation, according to embodiments of the present disclosure.

FIG. 10 illustrates an example computing device, such as may be used in a location system, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As described herein for various embodiments, the present disclosure generally relates to Zone Ambiguity Condition Identification and Mitigation as may affect a real-time location system. Such location systems can utilize tags affixed to various objects or individuals for tracking the objects or individuals, a plurality of anchors where each anchor is associated with a single corresponding zone of a plurality of zones in a defined space, and a tracking system which implements a method for tracking the tag across various zones of the defined space based on signal parameters collected by the anchors. The method of tracking may operate in a uni-directional or a bi-directional mode, with the anchors acting as receivers of beacon signals from the tag, or as transceivers that poll the tag and receive responses from the tag that are used to track the location of the tag. The tracking system receives and analyzes the signals received by the anchors from the tag to determine in which zone a tag is located, and to adjust various signaling parameters to mitigate or overcome a zone ambiguity condition, in which a tag is located alternatingly in multiple zones during a window of time that prevents determining a location for that tag.

In some embodiments, a method, a system (including a processor and a memory storing instructions for performing operations the method), or a non-transitory computer readable (storing instructions that, when executed by a processor, perform operations of the method) is provided, the method, comprising: transmitting a poll request to a tag via one or more anchors of a plurality of anchors respectively positioned in a plurality of zones; receiving poll request responses from at least two anchors of the plurality of anchors when the at least two anchors of the plurality of anchors receive a signal from the tag; storing the poll request responses received from the at least two anchors to a first queue; storing a weight for each anchor of the at least two anchors to a second queue; identifying a zone of the plurality of zones in which the tag is located based on the second queue; and modifying a transmission signal power of the tag when the tag exhibits a zone ambiguity condition associated with the identified zone and at least one other zone of the plurality of zones in which the tag was previously located.

In some such embodiments, when the at least two anchors of the plurality of anchors receive the signal from the tag, each anchor of the at least two anchors: identifies a tag identification (ID); determines a set of parameters including a Received Signal Strength Indicator (RSSI), an azimuth of the tag, and an elevation of the tag; and transmits the tag ID, the set of parameters, and an anchor ID of the given anchor to a tracking system.

In some such embodiments, the method further comprises comparing a first anchor ID of a first received poll request response from the tag with a highest anchor ID associated with a highest weight in the second queue; and incrementing, when the first anchor ID does not match the highest anchor ID, a current jitter counter.

In some such embodiments, the method further comprises comparing a second anchor ID of a second received poll request response from the tag after the first anchor ID was received with the highest anchor ID associated with the highest weight in the second queue; comparing the current jitter counter against a jitter counter threshold when the second anchor ID matches the highest anchor ID and the current jitter counter is not equal to zero; identifying that the tag exhibits the zone ambiguity condition when the current jitter counter is greater than the jitter counter threshold; and instructing, in response to identifying the tag exhibiting the zone ambiguity condition, the tag to enable a power diversity mode at the tag through the plurality of anchors.

In some such embodiments, the power diversity mode adjusts the transmission signal power of the tag to a different level and the transmission signal power of the tag remains unchanged until a next time the zone ambiguity condition is identified.

In some embodiments, a method, a system (including a processor and a memory storing instructions for performing operations the method), or a non-transitory computer readable (storing instructions that, when executed by a processor, perform operations of the method) is provided, the method, comprising: tracking a location of a tag among a plurality of zones via signals transmitted by the tag that are received by one or more anchors of a plurality of anchors, each anchor of the plurality of anchors being associated with a corresponding zone of the plurality of zones, and the tag being tracked as being located in no more than one zone of the plurality of zones at any given time; identifying that the tag exhibits a zone ambiguity condition; and modifying, in response to identifying the tag as exhibiting the zone ambiguity condition, a transmission power of the signals used to track the location of the tag until the tag no longer exhibits the zone ambiguity condition.

In some such embodiments, identifying the tag as exhibiting the zone ambiguity condition comprises: storing an anchor identification (ID) of each anchor of the plurality of anchors and a Received Signal Strength Indicator (RSSI) for the signals as received by each anchor of the plurality of anchors from the tag to fill a first queue; weighting the first queue based on a number of entries for each anchor of the plurality of anchors in the first queue and associated RSSIs thereof to generate a weight for each anchor of the plurality of anchors in a second queue; and tracking, based on a current jitter counter value relative to a threshold, whether the tag is non-consecutively associated with a queued anchor of the plurality of anchors with a highest weight in the second queue.

In some such embodiments, tracking whether the tag is non-consecutively associated with the queued anchor further comprises: comparing a first anchor ID of a first received poll request response from the tag with a highest anchor ID associated with a highest weight in the second queue; incrementing, when the first anchor ID does not match the highest anchor ID, a current jitter counter; comparing a second anchor ID of a second received poll request response from the tag after the first anchor ID was received with the highest anchor ID associated with the highest weight in the second queue; and comparing the current jitter counter against the threshold when the second anchor ID matches the highest anchor ID and the current jitter counter is not equal to zero.

In some such embodiments, modifying the transmission power of the signals used to track the location of the tag further comprises, when the tag operates in a bi-directional communication mode with the plurality of anchors: instructing the tag to modify, based on an output of a random number generator, the transmission power at a subsequent polling time to be one of higher than or lower than the transmission power at a current polling time.

In some such embodiments, modifying the transmission power of the signals used to track the location of the tag further comprises, when the tag operates in a uni-directional communication mode with the plurality of anchors: receiving a plurality of beacon signals from the tag with different power levels in response to a polling interval occurring; and selecting a given beacon signal from the plurality of beacon signals for a current polling time with a different power level than a previously selected beacon signal for a previous polling time.

In some such embodiments, the method further comprises tracking a duration that the tag exhibits the zone ambiguity condition; and transmitting, in response to the duration satisfying a threshold, an alert to a device associated with the tag.

In some such embodiments, the method further comprises instructing the tag to reserve use of a highest available transmission power level when exhibiting the zone ambiguity condition.

In some such embodiments, the method further comprises tracking a duration that the tag does not exhibit the zone ambiguity condition; and transmitting, in response to the duration satisfying a threshold, an instruction to the tag to reduce the transmission power.

Due to the nature of signal propagation in an environment (e.g., a defined space), the tracking system makes alternating determinations for which zone to locate a tag in, which is referred to herein as a “zone ambiguity condition”. The tracking system can detect a zone ambiguity condition when the tag is located in different zones alternatingly, which can prevent the tracking system from determining a final location for that tag. When the tracking system detects the zone ambiguity condition, the tracking system can mitigate the effect of the zone ambiguity condition, so that the tag may be located in a single zone. In some embodiments, a power diversity mode is enabled to mitigate the zone ambiguity condition, in which the tracking system instructs the tag (via commands forwarded from one or more anchors) to change the transmission signal power level for each poll time interval until the zone ambiguity condition is resolved, and a location of the tag is identified. In some embodiments, when the tag transmits beacon signals at multiple power levels for each polling interval, the tracking system may select one or more power levels to omit in a given poll time interval to establish power diversity when tracking the tag in the environment.

In real-time location systems, locating objects and individuals with minimal latency is highly desirable. For example, in scenarios where safety and security are paramount (e.g., in a healthcare environment), reducing latency ensures that the emergency response teams can react promptly to incidents (e.g., accidents). In scenarios of logistic and supply chain management, reducing latency improves processes, providing for more efficient routing of assets and thereby reducing wait time and improving overall productivity. Reducing latency is also beneficial for tracking accuracy. A delay in the response of a tracking system can yield outdated location data, leading to inaccurate tracking that can impact safety and security in applications such as healthcare, public safety, and asset tracking. The present disclosure therefore provides improvements to the operations and functionalities of the associated location system to detect and resolve a zone ambiguity condition, such that the system can mitigate the harmful effects associated with zone ambiguity conditions in locating objects and individuals, among other benefits and practical applications that those of skill in the relevant art will recognize on a detailed reading of the present disclosure.

As used herein, the term “located” refers to a computational determination of location, which does not necessarily match a physical location of an object. In contrast, the term “positioned” is used herein to refer to a physical location of an object, which does not necessarily match an identified or tracked location of an object. For example, a system may locate an object in a first area while that the object is actually positioned in a second area, different than the first area.

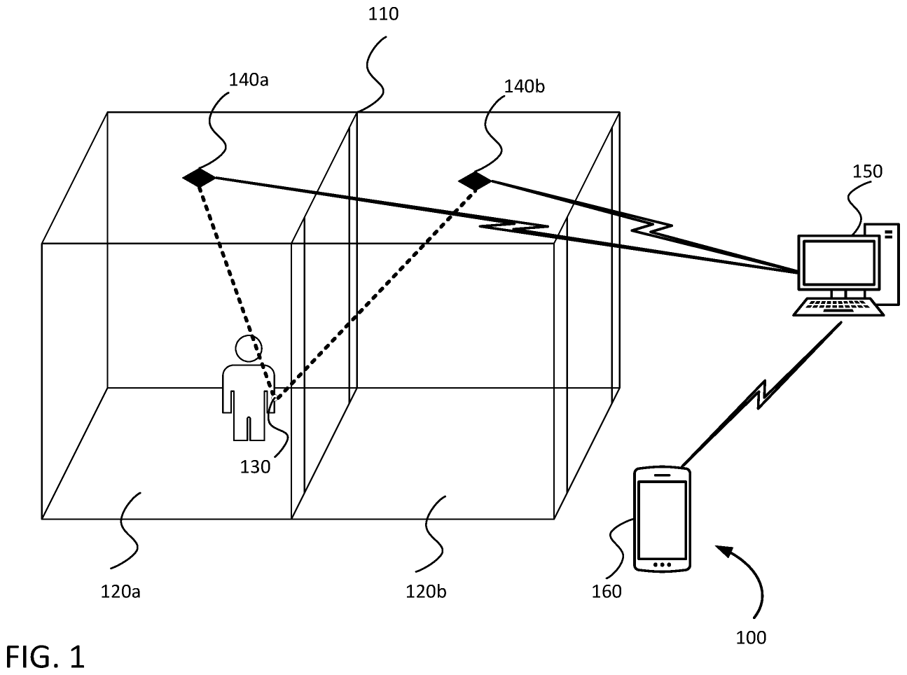

FIG. 1 illustrates a perspective view of an exemplary arrangement of a location system 100, according to embodiments of the present disclosure. As illustrated, the location system 100 can track objects or individuals within a defined space 110 including a first zone 120a and a second zone 120b (generally or collectively, zones 120). An individual stands inside the first zone 120a, wearing a tag 130. Anchors 140a-b (generally or collectively, anchors 140) are deployed in the defined space 110, with a first anchor 140a mounted on the ceiling of the first zone 120a, and a second anchor 140b mounted on the ceiling of the second zone 120b. A tracking system 150, which may be remote or local to the defined space 110, communicates with the anchors 140 through various wired and/or wireless networks. A supervisory device 160, which may be remote or local to the defined space 110, may communicate with the tracking system 150 to receive alerts from the tracking system 150, request location updates on one or more tags 130, request presence data for one or more zones 120 (e.g., which tags 130 are located in a given zone 120), request history reports for various tags 130 and zones 120, and combinations thereof.

In one example, the individual wearing the tag 130 can be a patient, and the defined space 110 can be a healthcare facility. When the individual needs medical aid, the location system 100 locates the individual via the tracking system 150 coordinating the anchors 140 and the tag 130 and transmits the identified location of the individual to the supervisory device 160. In another example, the individual may be tracked to ensure that the individual remains within a designated area of the healthcare facility (e.g., a high-oxygen environment, a neonatal wing, a quarantine area), and the location system 100 alerts supervisory devices 160 when the individual is not within the designated area. In another example, a user of the supervisory device 160 may wish to know the position of the individual, and requests the tracking system 150 to identify the location of the individual via the associated tag 130. Other examples in which the location system 100 may be used include tracking parcels, medical/scientific samples, livestock, individuals or vehicles engaged in sport, and the like.

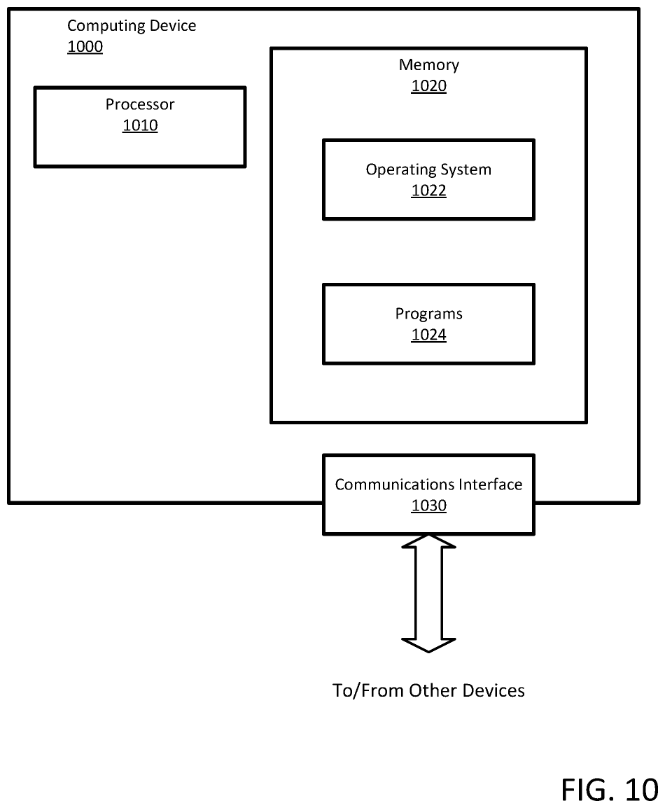

Each anchor 140 may include a wireless communications module and antenna to receive (and optionally transmit) wireless signals, a microcontroller to process data and control operations, and an interface port to communicate with the tracking system 150. In various embodiments, the anchors 140 each may include, or two or more anchors 140 may share, a computing device that controls the operation of the anchor 140, such as the computing device (1000) described in greater detail in regard to FIG. 10. Although illustrated as being mounted to a ceiling, the present disclosure contemplates that the anchors 140 may be mounted or deployed at various locations throughout the defined space 110.

The tag 130 may include an integrated circuit (IC) to store a unique tag identification (ID) of the tag 130 and process tasks, which may include encryption and security features, and an antenna to transmit (and optionally receive) wireless signals. The tag 130 may be a Bluetooth Low Energy (BLE) standard compliant device, which can be configured to manage several standard or non-standard functions, such as tuning a transmission power level. In various embodiments, the tag 130 may include a computing device that controls the operation of the tag 130, such as the computing device (1000) described in greater detail in regard to FIG. 10.

The tracking system 150 may include a processor, which executes a software program stored in a memory, and a communication interface to establish communications with the anchors 140 over various wired and wireless networks. In various embodiments, the tracking system 150 may include a computing device that controls the operation of the tracking system 150, such as the computing device (1000) described in greater detail in regard to FIG. 10.

The supervisory device 160 may be a desktop computer, a pager, a smartphone, a tablet, or various other computing devices (1000) such as those described in greater detail in regard to FIG. 10.

In some embodiments, the anchors 140 and the tag 130 can both transmit and receive signals (e.g., a bi-directional configuration). Under the control of the tracking system 150, the anchors 140 send poll requests to the tag 130 at a pre-determined time schedule or in response to a request to locate the tag 130. The tag 130 receives and responds to the poll requests by transmitting signals with an adjustable transmission power level. One or more anchors 140 receive the signals from the tag 130, process the signals (e.g., by calculating a set of parameters including RSSI, azimuth and elevation, or other parameters), and then report the set of parameters along with the tag ID of the tag 130 and an anchor ID of that anchor 140 to the tracking system 150. The tracking system 150 receives the parameters from the one or more anchors 140, and further processes the parameters through a program specifically designed for the real-time location system 100 to locate the tag 130. The tracking system 150 may then forward the location determination or an alert based on the location determination to the supervisory device 160.

In some embodiments, the anchors 140 only receive signals and the tag 130 only transmits signals (e.g., a uni-directional configuration). The tag 130 transmits beacon signals based on a pre-determined time schedule and a pre-determined transmit power level. One or more anchors 140 receive the signals from the tag 130, process the received signals (e.g., by calculating a set of parameters including RSSI, azimuth and elevation, or other parameters), and then report the set of parameters along with the tag ID of the tag 130 and the anchor ID of that anchor 140 to the tracking system 150. The tracking system 150 receives the parameters from the anchors 140, and further processes the parameters through a program specifically designed for the real-time location system 100 to locate the tag 130. The tracking system 150 may then forward the location determination or an alert based on the location determination to the supervisory device 160.

In various embodiments, the location system 100 may operate solely in the uni-directional configuration, solely in the bi-directional configuration, or may alternate between the configurations (either at different times or at different areas in the defined space 110).

Generally, the tracking system 150 locates the tag 130 in the zone 120 associated with the anchor 140 that reports the strongest signal from the tag 130. However, when the individual or object associated with the tag 130 moves to a position where the anchors 140 of two or more zones 120 can both receive signals from the tag 130, such as the border or other overlapping signal area, the anchor 140 that reports the strongest signal from the tag 130 may alternate (e.g., due to multi-pathing, signal echo, transient interference sources, etc.). To increase the confidence in the location determination, the tracking system 150 may require that a given anchor 140 be identified as receiving the strongest signal for a threshold number of times before identifying that the tag 130 is located in the zone 120 associated with that anchor 140. However, when the anchor 140 with the strongest signal from the tag 130 continues to alternate (e.g., locating the tag 130 in different zones 120 alternatingly if not for the confidence threshold), the tag 130 may be identified as exhibiting a zone ambiguity condition. Rather than abandoning the confidence threshold or reporting that the tag 130 is located in both zones 120 or a last-identified zone 120, the tracking system 150 described herein is able to resolve the zone ambiguity condition by enabling a power diversity mode to change the power level of the signals transmitted by the tag 130 that are used to locate the tag 130.

Although illustrated with a given number of zones 120, tags 130, anchors 140, and supervisor devices 160, the present disclosure contemplates that more or fewer zones 120, tags 130, anchors 140, and supervisory devices 160 may be present in the defined space 110 for use in conjunction with the concepts described herein. Additionally, although generally discussed in relation to tracking a single tag 130 in the examples provided herein, the present disclosure contemplates that the tracking actions (and zone ambiguity condition resolution) operations may be performed in parallel for a plurality of tags 130.

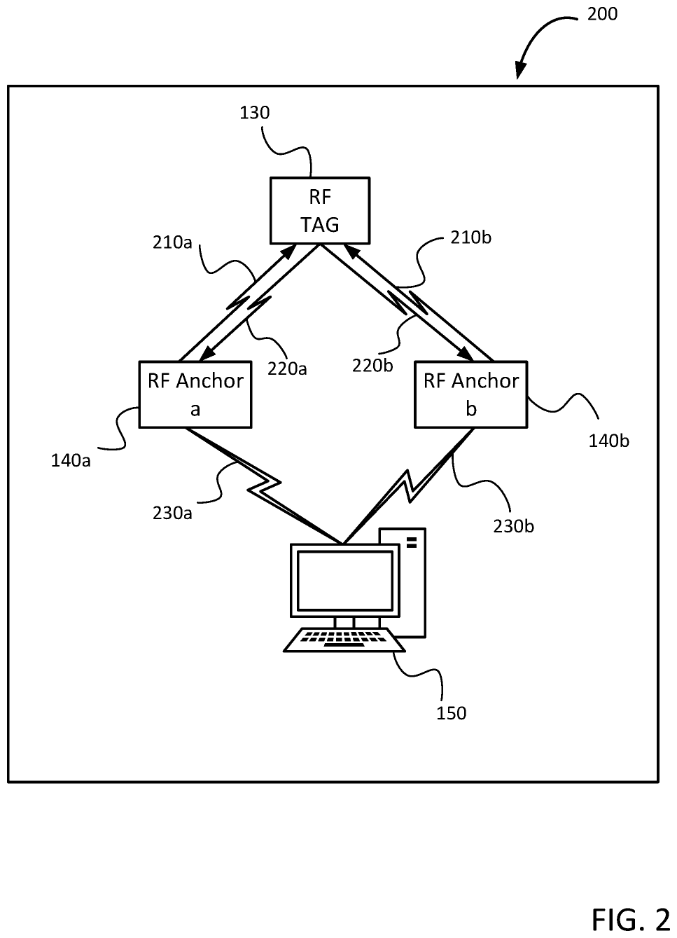

FIG. 2 is a diagram depicting the communications between different components in the location system in a bi-directional configuration, according to embodiments of the present disclosure. As illustrated, in a bi-direction configuration 200, both the tag 130 and the anchors 140 can transmit and receive signals. The tracking system 150 communicates with the anchors 140 through communication links 230a-b (generally or collectively, communication links 230). The communication links 230 might be wired or wireless, including USB, RS-232, Ethernet, and Wi-Fi links.

To locate the tag 130, the tracking system 150 instructs the anchors 140, via the communication links 230, to send poll requests to the tag 130. As illustrated, through transmitting links 210a-b (generally or collectively, transmitting links 210), the anchors 140 send the poll requests to the tag 130. After receiving the poll requests, the tag 130 responds to the poll requests by sending signals through receiving links 220a-b (generally or collectively, receiving links 220). After receiving the signals from the tag 130 through the receiving links 220, one or more anchors 140 calculate a set of parameters, which may include RSSI, azimuth and elevation from which the signals were received, and other parameters, and then send the set of parameters, along with the tag ID of the tag 130 and the anchor ID of that anchor 140 to the tracking system 150 through the communication links 230 for further processing to locate the tag 130.

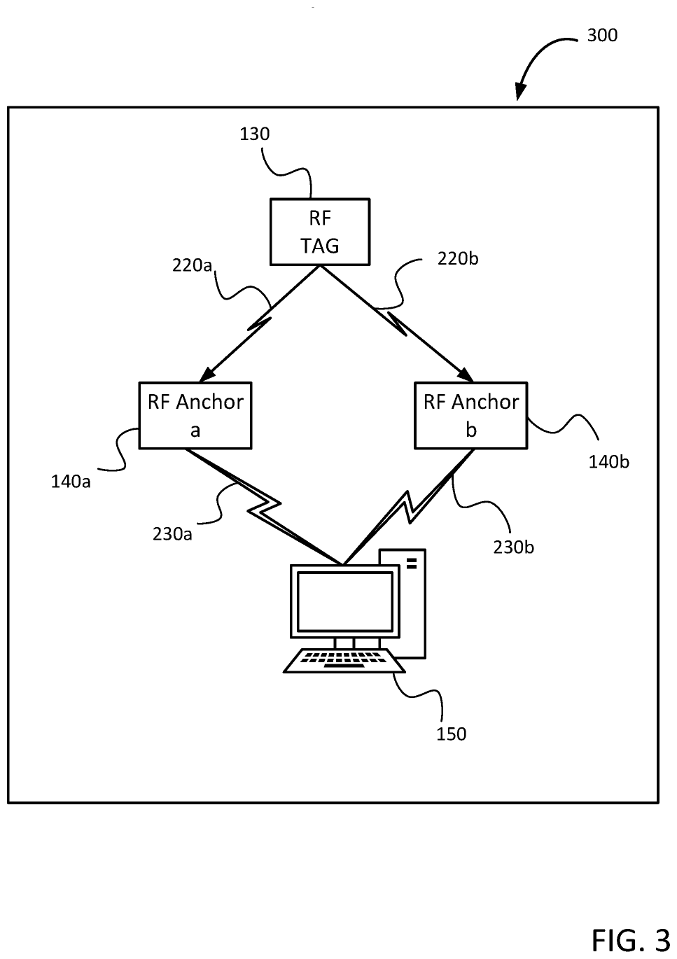

FIG. 3 is a diagram depicting the communications between different components in the location system in a uni-directional configuration, according to embodiments of the present disclosure. As illustrated, in a uni-directional configuration 300, the tag 130 may only transmit signals, and the anchors 140 may only receive signals. This configuration offers benefits related to power consumption, bandwidth usage, timing (e.g., not having to wait for and process poll requests), and simplified hardware among the devices. Similarly to the bi-direction configuration 200, the tracking system 150 communicates with the anchors 140 through communication links 230. The communication links 230 might be wired or wireless, including USB, RS-232, Ethernet, and Wi-Fi links.

To locate the tag 130, the tag 130 transmits beacon signals via the receiving links 220 at a pre-determined time schedule or in response to a triggering event detected via the tag 130. After receiving the beacon signals from the tag 130, one or more anchors 140 calculate a set of parameters, which may include RSSI, azimuth and elevation from which the signals were received, and other parameters, and then send the set of parameters, along with the tag ID of the tag 130 and the anchor ID of that anchor 140 to the tracking system 150 through the communication links 230 for further processing to locate the tag 130.

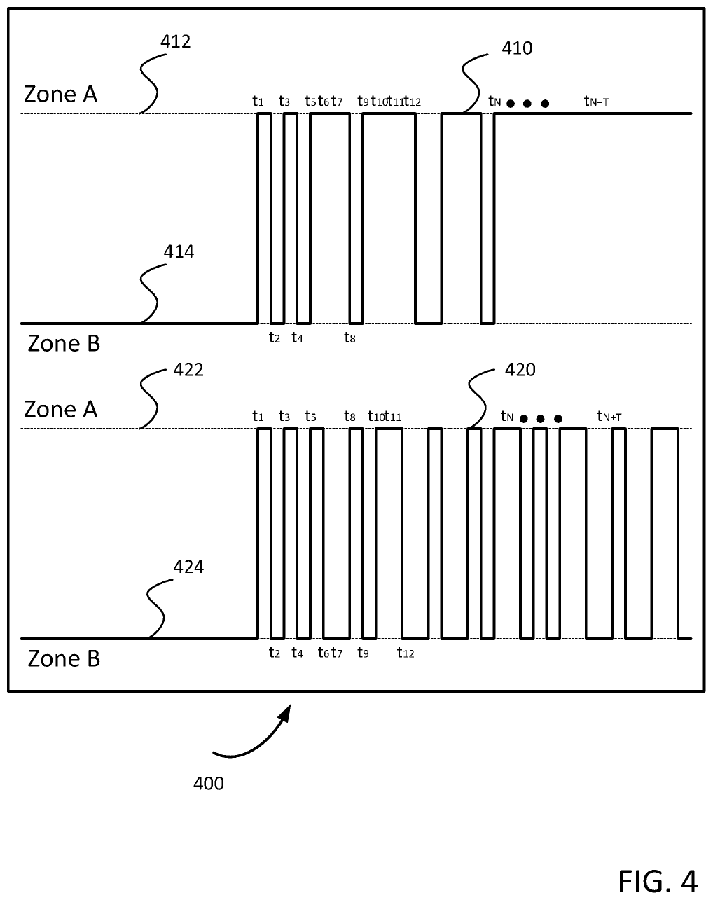

FIG. 4 is an example timing diagram illustrating a zone ambiguity condition, according to embodiments of the present disclosure. A zone ambiguity condition occurs when the anchor 140 with the strongest signal received from the tag 130 continues to alternate, either for a period of time non-perpetually or perpetually. In such a case, the tracking system 150 locates the tag 130 alternatingly in different zones 120.

The timing diagram 400 depicts two types of zone ambiguity condition. The first timing diagram 410 demonstrates a non-perpetual zone ambiguity condition which begins from t₁ but ends at t_{N}. As illustrated, the tracking system 150 identifies the location of the tag 130 in a first zone 120a via a Zone A decision 412 or in a second zone 120b via a Zone B decision 414 alternatingly during the time period from t₁ to t_{N}. For example, at time t₁, the tracking system 150 locates the tag 130 in the first zone 120a by making a Zone A decision 412, however at time t₂ the tracking system 150 locates the tag 130 in the second zone 120b by making a Zone B decision 414.

As will be appreciated, the tracking system 150 may identify the tag 130 as being located in one zone 120 multiple times in a row, but the tag 130 may still exhibit the zone ambiguity condition if the number of location determinations within a window of time (consecutive or otherwise) is below a confidence threshold number of times. For example, the tracking system 150 may identify four times in a row (e.g., from t₉ to t₁₂ that the tag 130 is located in the first zone 120a, but if the confidence threshold is greater than four, the tag 130 is still understood to exhibit the zone ambiguity condition. After the time t_{N}, the zone ambiguity condition is resolved (e.g., at time t_{N+T}, where T is the confidence threshold number), and the tracking system 150 consistently locates the tag 130 in the first zone 120a by making consecutive Zone A decision 412 for at least a threshold number of times, resulting in a final determination of the location of the tag 130 with a high confidence.

The second timing diagram 420 demonstrates a perpetual zone ambiguity condition which begins from t₁ but does not resolve in the second timing diagram 420. As illustrated, even after time t_{N}, the tracking system 150 continues to make a Zone A decision 422 and a Zone B decision 424 alternatingly without being able to determine a final location of the tag 130.

The non-perpetual zone ambiguity condition, although finally resolved, is undesirable when attempting to promptly locate the tag 130. The perpetual zone ambiguity condition is even less desirable, as not being able to locate the tag 130 promptly which may require an intervention from a supervisory device 160 or a human being. The tracking system 150 described herein is able to resolve both non-perpetual and perpetual zone ambiguity conditions by changing the transmit signal power level of the signals used to locate the tag 130.

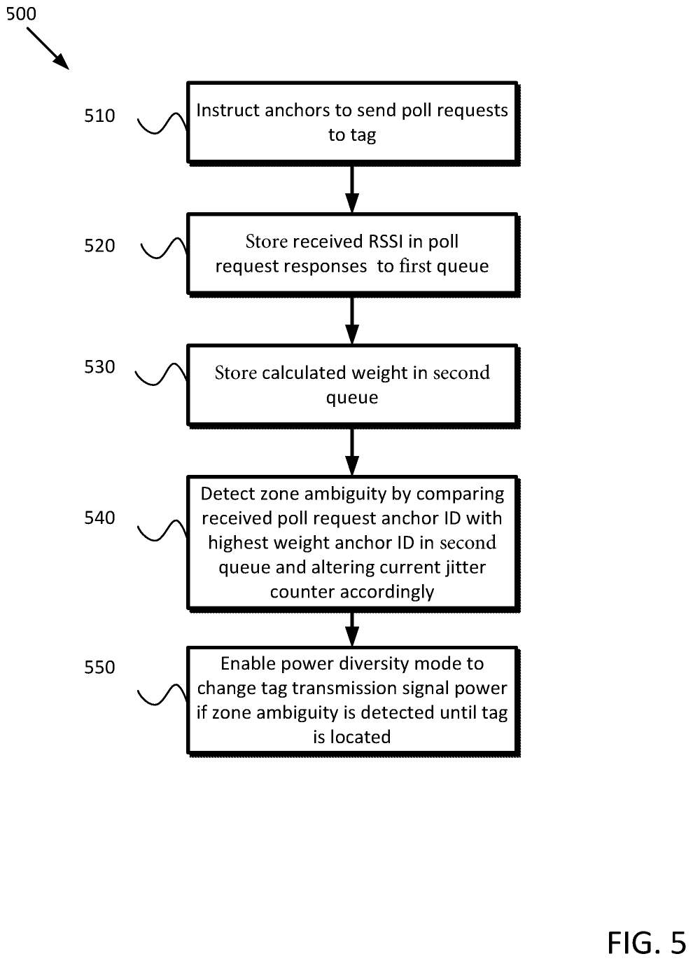

FIG. 5 is a flowchart of an example method 500 of locating an object or an individual wearing a tag 130 in a bi-directional configuration, according to embodiments of the present disclosure. Method 500 begins at block 510, where the tracking system 150 instructs the anchors 140, via the communication links 230, to transmit poll requests to the tag 130. In various embodiments, the poll requests may be transmitted based on a time schedule set by the tracking system 150, a request from a supervisory 160 device, or other triggering conditions. The poll requests from the anchors 140 are transmitted through the transmitting links 210. When the tag 130 receives the poll requests from one or more of the anchors 140, the tag 130 responds to the poll requests by sending signals through the receiving links 220. The one or more anchors 140 receive the signals sent from the tag 130 through the receiving links 220, calculate a set of parameters including, but not limited to, RSSI, azimuth and elevation, and transmit the set of parameters, along with the tag ID of the tag 130 and the anchor ID of that anchor 140 to the tracking system 150.

At block 520, the tracking system 150 receives the poll request responses from the one or more anchors 140 via the communication links 230 and stores the RSSI in the poll request responses to a first queue, also referred to as a history queue. The size of the first queue may be pre-determined or adjustable during real-time operation, and may be one dimensional or two dimensional. The tracking system 150 continues to store the poll request responses to the first queue until the first queue is full, and may shift out the oldest RSSI to make room in the queue for the RSSI in the newly received poll request response.

At block 530, once the first queue is full, the tracking system 150 calculates a weight for each of the anchors 140 based on the RSSI received in the poll request responses associated with that anchors 140. The weight for each of the anchors 140 is then stored to a second queue, also referred to as a weighted queue. An index in the second queue is associated with the anchor ID of each of the anchors 140 and a value at the index corresponds to the weight of the anchor 140 whose anchor ID matches with the index.

At block 540, the tracking system 150 detects whether the tag 130 exhibits a zone ambiguity condition by comparing the anchor ID of the next received poll request response with the anchor ID associated with the highest weight in the second queue. A current jitter counter, initialized to a pre-determined jitter counter threshold, is altered based on the comparison results and used to detect the zone ambiguity condition.

At block 550, when the zone ambiguity condition is identified for the tag 130, the tracking system 150 instructs the anchors 140 enable a power diversity mode in the tag 130 to change the signal transmission power level of the tag 130. The tracking system 150 continues to analyze the received poll request responses by comparing the anchor ID of the received poll request responses with the anchor IDs associated with the highest weight in the second queue, until the zone ambiguity condition is resolved and the tag 130 is successfully located in a zone 120.

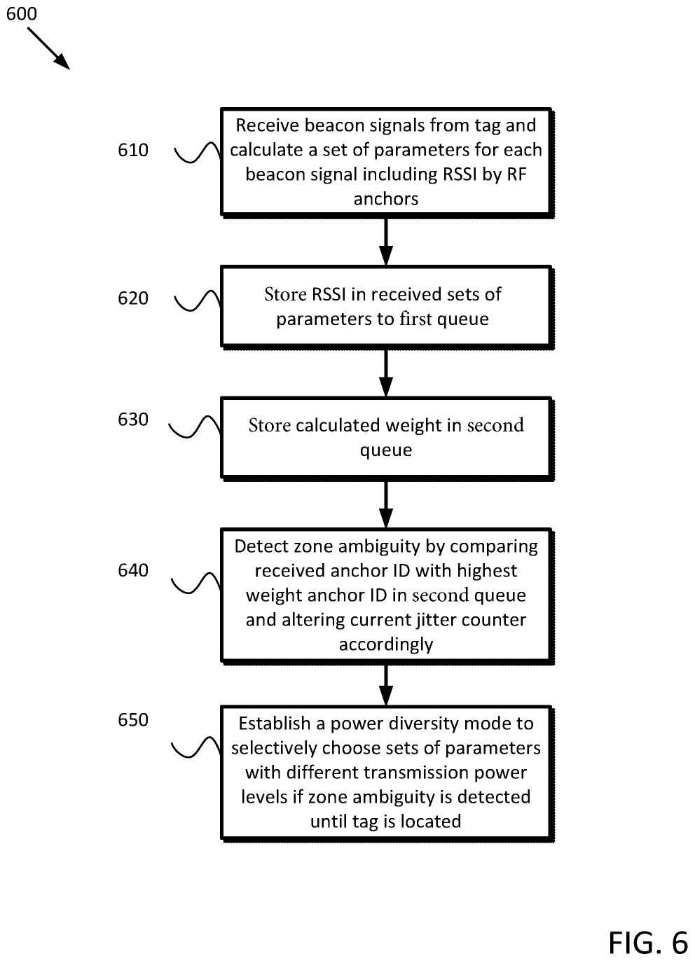

FIG. 6 is a flowchart of an example method 600 of locating an object or an individual wearing a tag 130 in a uni-directional configuration, according to embodiments of the present disclosure. Method 600 begins at block 610, where one or more anchors 140 receive the beacon signals transmitted from the tag 130 through the receiving links 220. The anchors may calculate a set of parameters for each beacon signal including, but not limited to, RSSI, azimuth, and elevation, and transmit the set of parameters, along with the tag ID of the tag 130 and the anchor ID of that anchor 140 to the tracking system 150. In the uni-directional configuration, one of the parameters may include a nominal power level for a received signal, so that multiple beacon signals sent by one tag 130 in one polling interval can be differentiated from some another.

At block 620, the tracking system 150 receives the sets of parameters from the one or more anchors 140 via the communication links 230, and selectively stores the RSSI in the sets of parameters to a first queue, also referred to as a history queue. The size of the first queue may be pre-determined or adjustable during real-time operation, and may be one dimensional or two dimensional. The tracking system 150 continues to store the RSSI to the first queue until the first queue is full, and may shift out the oldest RSSI to make room in the queue for the RSSI in the newly received set of parameters.

At block 630, once the first queue is full, the tracking system 150 calculates a weight for each of the anchors 140 based on the RSSI received in the sets of parameters associated with that anchors 140. The weight for each of the anchors 140 is then stored to a second queue, also referred to as a weighted queue. An index in the second queue is associated with the anchor ID of each of the anchors 140 and a value at the index corresponds to the weight of the anchor 140 whose anchor ID matches with the index.

At block 640, the tracking system 150 detects whether the tag 130 exhibits a zone ambiguity condition by comparing the next received anchor ID with the anchor ID associated with the highest weight in the second queue. A current jitter counter, initialized to a pre-determined jitter counter threshold, is altered based on the comparison results and used to detect the zone ambiguity condition.

At block 650, when the zone ambiguity condition is identified for the tag 130, the tracking system 150 simulates a power diversity mode by selectively choosing one or more power levels for the beacon signals to use or ignore across polling intervals. Accordingly, although the tag 130 continues to transmit multiple beacon signals at different power levels in upcoming polling intervals, and the anchors 20 continue to calculate parameters and forward those parameters to the tracking system 150, the tracking system 150 may not utilize all of the forwarded information. Instead, the tracking system 150 selects one or more different power levels to use in each interval. The tracking system 150 continues to analyze the selected set or sets of parameters by comparing the received anchor ID with the anchor IDs associated with the highest weight in the second queue, until the zone ambiguity condition is resolved and the tag 130 is successfully located in a zone 120.

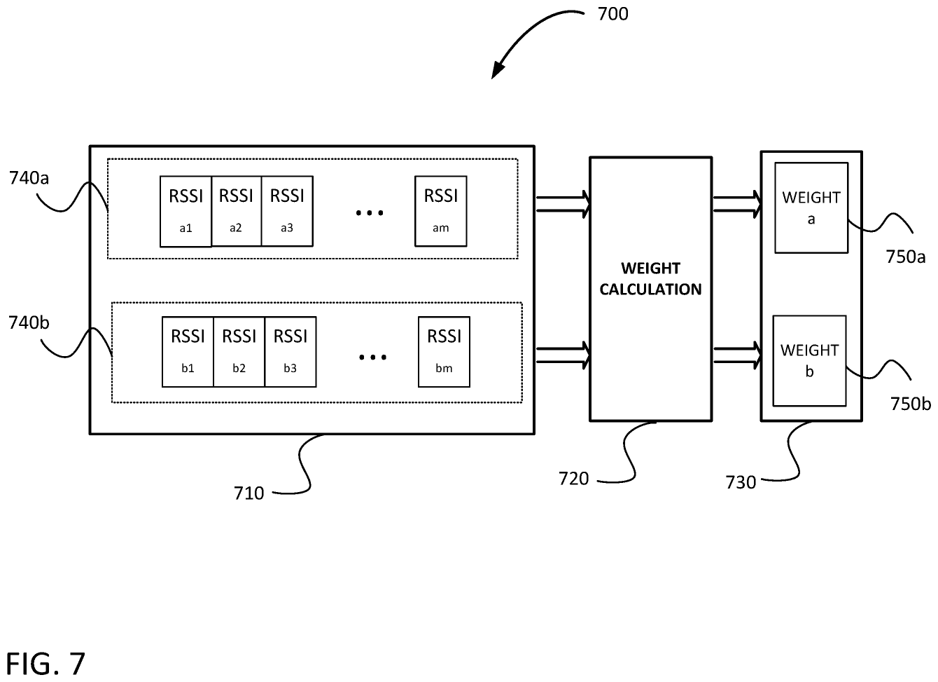

FIG. 7 illustrates a formulation of an example first (history) queue and a conversion from the example first (history) queue to an example second (weighted) queue, according to embodiments of the present disclosure. As illustrated, the formulation 700 begins with a two dimensional first queue 710, which includes first queue rows 740a-b (generally or collectively, first queue rows 740). Each of the first queue rows 740 stores a size of m RSSI values from the number of m sets of parameters received from one of the anchors 140. The weight calculation block 720 takes each of the first queue rows 740, accumulates the size of m RSSI values, generates and stores a weight to the second queue 730.

As illustrated in FIG. 7, in the second queue 730, the first weight 750a represents the weight of the first anchor 140a and the second weight 750b represents the weight of the second anchor 140b. In various embodiments, each of the first queue rows 740 is a first-in first-out (FIFO) queue. When one of the history queue rows 740 associated with a given anchor 140 is full, the RSSI of the next received set of parameters from the given anchor 140 is stored to that first queue row 740 by removing the oldest RSSI. Each time the first queue 710 is updated, the second queue 730 is updated through the weight calculation block 720. Although illustrated in FIG. 7 as each of the first queue rows 740 having the same size of m, the present disclosure contemplates that each of the first queue rows 740 may have a different size, which are calibrated in advance and based on the sensitivity of each of the anchors 140.

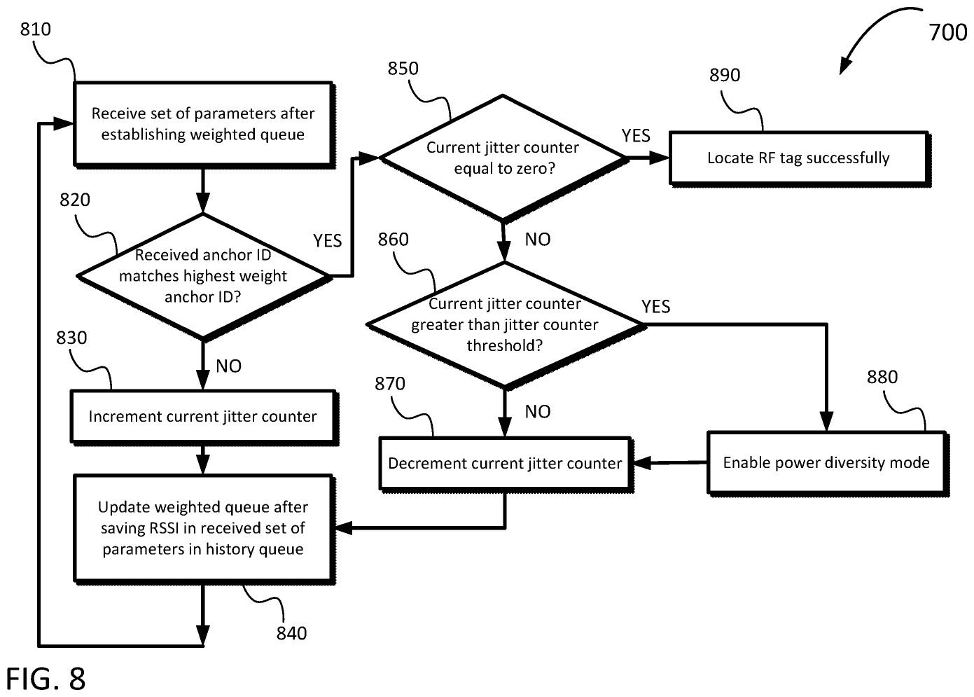

FIG. 8 is a flowchart of an example method 800 of detecting and handling a zone ambiguity condition, according to embodiments of the present disclosure. In various embodiments, method 800 may be understood as discussing operations related to those described in block 540 and block 550 in method 500 (see e.g., FIG. 5) or in block 640 and block 650 in method 600 (see e.g., FIG. 6).

At block 810, the tracking system 150 receives a set of parameters which may be a poll request response in the bi-directional configuration or calculated for a received beacon signal in the uni-directional configuration from one of the anchors 140.

At block 820, the tracking system 150 checks whether the received anchor ID matches (from block 810) with the anchor ID associated with the highest weight in the second queue 730. When the received anchor ID does not match with the anchor ID associated with the highest weight in the second queue 730, method 800 proceeds to block 830. Otherwise, when the received anchor ID matches with the anchor ID associated with the highest weight in the updated second queue 730 in block 820, method 800 proceeds to block 850.

At block 830, the tracking system 150 increases a value for the current jitter counter. In various embodiments, the tracking system 150 initializes the value of the jitter counter to the jitter counter threshold, but the value held in the current jitter counter may vary during the course of method 800 to reflect how frequently the tracking system 150 “jitters” in where the tag 130 is located (e.g., between Zone A decisions and Zone B decisions). In various embodiments, the tracking system 150 increments the current jitter counter at block 830 by a pre-determined step size, which may be one or another positive number.

At block 840, the RSSI in the received set of parameters is stored to the first queue row 740 associated with the received anchor ID in the first queue 710 and the weight 750 associated with the received anchor ID is updated through the weight calculation block 720 and stored to the second queue 730. Method 800 may then return to block 810 to receive the next set of parameters.

Each time when the received anchor ID does not match with the anchor ID associated with the highest weight in the second queue 730, the current jitter counter increases. Therefore, a large current jitter counter (especially when greater than the jitter counter threshold) indicates that for at least one or more times, the anchor 140 from which the set of parameters was received does not match with the anchor 140 associated with the highest weight in the second queue 730, whose location in one of the zones 120 is considered as the most possible location where the tag 130 is located. Accordingly, the tag 130 is exhibiting a zone ambiguity condition, which may be resolved naturally, or require the tracking system 150 to resolve the zone ambiguity by enacting a power diversity mode.

At block 850, the tracking system 150 checks whether the current jitter counter is equal to zero. When the jitter counter is not equal to zero, method 800 proceeds to block 860. Otherwise, when the jitter counter is currently equal to zero, method 800 proceeds to block 890.

At block 860, the tracking system 150 further checks whether the current jitter counter is greater than the jitter counter threshold. When the current jitter counter is greater than the jitter counter threshold, method 800 proceeds to block 880, where the tracking system 150 detects a zone ambiguity condition and enables the power diversity mode. Otherwise, method 800 proceeds to block 870.

When operating in a bi-directional configuration, the tracking system 150 instructs the anchors 140 to notify the tag 130, through the transmission links 210 to operate in a power diversity mode. In the power diversity mode, the tag changes the transmission signal power level, either based on a random or a pre-programmed power sequence, for successive polling responses. For example, a BLE compliant tag 130 can tune the transmission power as a standard functions. In various embodiments, the change in transmission power level can be continuous or discrete within a pre-defined sliding scale. The anchors 140 may instruct the tag 130 to increase or decrease power under the control of the tracking system 150. In some embodiments, after resolving an initial zone ambiguity condition, the transmission power level used by the tag 130 may stay the same until the next time the zone ambiguity condition is detected at block 880.

When operating in a uni-directional configuration, one or more anchors 140 receive a plurality of beacon signals from the tag 130 with different power levels in response to a polling interval occurring. The tracking system 150 receives the several beacon signals of differing power levels from the tag 130 (via the one or more anchors 140) and determines which beacons to use in determining a location for the tag 130. When operating with a power diversity mode enabled for a uni-directional configuration, the tracking system may select, via a random or pre-programmed sequence, which power levels of the beacon signals to use when locating the tag 130 so that different power levels are considered (or ignored) during successive polling intervals.

In various embodiments, to conserve power and ensure that the tag 130 has multiple power levels at which to transmit, the tracking system 160 may instruct the tag 130 (via the anchors 140) to reserve use of one or more of the highest available transmission power levels until a power diversity mode is enabled. The tracking system 160 may also track a duration for how long the tag 130 does not exhibit the zone ambiguity condition, and instruct, in response to the duration satisfying a power saver threshold, the tag 130 (via the anchors 140) to reduce the transmission power from. In the case that the zone ambiguity condition persists after enabling the power diversity mode, the tracking system 150 may track a duration for how long the tag 130 exhibits the zone ambiguity condition, and transmit in response to the duration satisfying an alert threshold, an alert to a supervisory device 140 associated with the tag 130 so that an operator may ascertain the position of the tag 130 or if a technical difficulty has occurred.

Method 800 may proceed to block 870 after block 880 or in response to determining (per block 860) that the current jitter counter is not greater than a jitter counter threshold.

At block 870, the tracking system 150 decrements the current jitter counter by a pre-determined step size, which may be one or another positive number. After decrementing the current jitter counter at block 870, method 800 proceeds to block 840, where the poll request response is stored to the first queue row 740 associated with the received anchor ID in the first queue 710 and the weight 750 associated with the received anchor ID is updated through the weight calculation block 720 and stored to the second queue 730. Then the method 800 returns to block 810 when the tracking system 150 receives the next set of parameters.

Each time when the received anchor ID matches with the anchor ID associated with the highest weight in the second queue 730 (and the current jitter counter is not equal to zero), the value stored in jitter counter decreases. While the jitter counter has a value of zero, the tracking system can confidently locate the tag in one zone (e.g., the zone associate with the anchor historically reporting the highest RSSI from the tag). While the jitter counter is greater than zero, but less than the jitter count threshold, the tracking system is unable to confidently locate the tag in a single zone (as multiple anchors have reported that the tag offers the strongest signal in two or more associated zones), but the confusion may be transient or otherwise naturally resolved without intervention from the tracking system. In contrast, when the value of the jitter counter is greater than the jitter counter threshold, the tracking system may have been unable to confidently locate the tag 130 for long enough to cause operational difficulties, and therefore takes action to resolve the zone ambiguity condition rather than continue to wait for a natural resolution.

At block 890, when the tracking system 150 identifies (per block 850) that the current jitter counter is equal to zero, the tracking system 150 locates the tag 130 in the zone 120 associated with the received anchor 140 which matches the anchor 140 associated with the highest weight in the second queue. Because the current jitter counter was initialized to the jitter counter threshold, and increases each time when the received anchor ID does not match the anchor ID associated with the highest weight in the second queue 730, the received anchor ID may need to match the anchor ID associated with the highest weight in the second queue 730 for at least the jitter counter threshold number of times to locate the tag 130 successfully for a first location determination. However, because the second queue 730 is weighted, the tracking system 150 may make subsequent location determinations without having to identify the tag 730 the jitter counter threshold number of times in a row within the same zone 120.

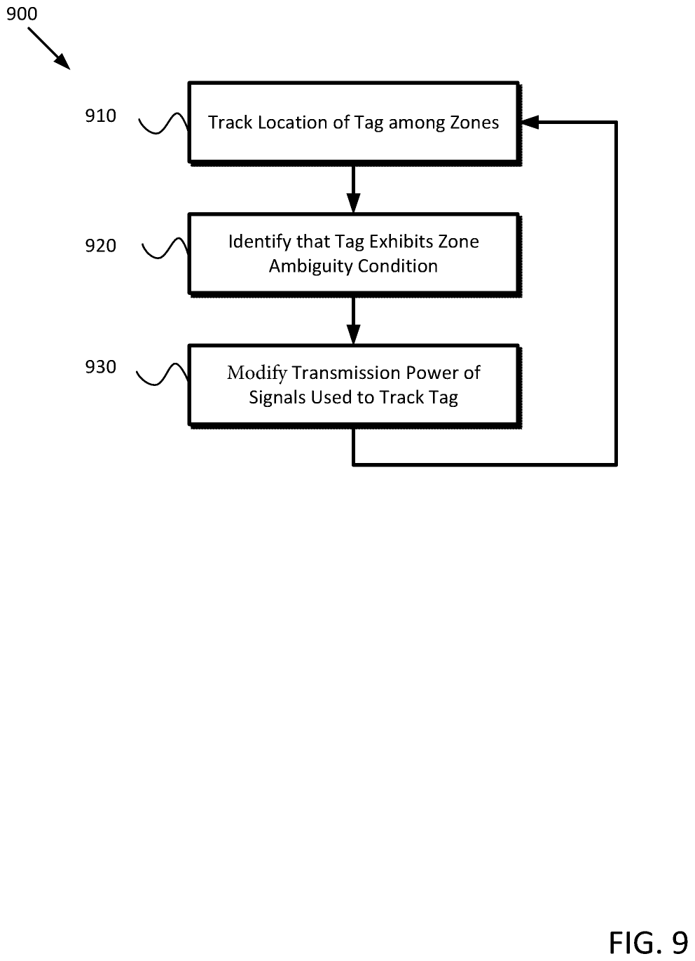

FIG. 9 is a flowchart for an example method 900 for Zone Ambiguity Condition Identification and Mitigation, according to embodiments of the present disclosure.

Method 900 begins at block 910, where a tracking system tracks the location of a tag among a plurality of zones via signals transmitted by the tag. These signals are received by one or more anchors of a plurality of anchors that are associated with corresponding zones of the plurality of zones. The anchors forward metrics associated with these signals to a tracking system, which tracks the tag as being located in no more than one zone of the plurality of zones at any given time.

At block 920, the tracking system identifies that the tag is exhibiting a zone ambiguity condition. The zone ambiguity condition occurs when the tracking system identifies that the tag is located in different zones at successive polling times-potentially indicating that the tag is moving from a first zone to a second zone or is in an area of the environment that results in an ambiguous location determination such that the anchor for a zone that does not appear to have the highest historical strength signals from tag is identified as being where the tag should be located. Because the tracking system identifies the tag as being located in a single zone at a given time, when the zone ambiguity condition exists, the tracking system cannot confidently assign the tag to a given zone/location, and therefore does not identify the tag as being located in any zone until the zone ambiguity condition is resolved.

In some embodiments, the tag is identified as exhibiting the zone ambiguity condition by storing an anchor ID of each anchor of the plurality of anchors and a signal strength indicator (such as an RSSI, Signal to Noise Ratio (SNR), Received Channel Power Indicator (RCPI)) for the signals received by each anchor of the plurality of anchors from the tag to in a first queue. This first queue is then weighted based on a number of entries for each anchor of the plurality of anchors therein to generate a weight for each anchor of the plurality of anchors in a second queue. Then using the second queue, the tracking system tracks, based on a current jitter counter value relative to a jitter counter threshold, whether the tag is non-consecutively associated with a queued anchor of the plurality of anchors with a highest weight in the second queue.

In some embodiments, tracking whether the tag is non-consecutively associated with the queued anchor further includes comparing several anchor IDs over a period of time. For example, the tracking system may compare a first anchor ID of a poll request response received from the tag at a first time t₁ with a highest anchor ID associated with a highest weight in the second queue. When the tracking system receives a second poll request response from the tag at time t₂ (e.g., after time t₁), the tracking system compares the second anchor ID of a second received poll request response from the tag with the highest anchor ID associated with the highest weight in the second queue at time t₂. This process may continue for several times, incrementing the jitter counter when the anchor ID at a given time does not match the highest anchor ID in the second queue at the given time. The tracking system compares the current value of the jitter counter against the jitter counter threshold when the second anchor ID matches the highest anchor ID and the current jitter counter is not equal to zero.

At block 930, in response to identifying the tag as exhibiting the zone ambiguity condition (per block 920), a transmission power of the signals used to track the location of the tag is modified until the tag no longer exhibits the zone ambiguity condition. In various embodiments, the tracking system may monitor a duration for how long the zone ambiguity condition lasts so that the tracking system may transmit an alert to a supervisory device in response to the duration satisfying an alert threshold (indicating that the changes in transmission power could not resolve the zone ambiguity condition within a threshold time).

When the tracking system and the tag operate in a bi-directional communication mode with the anchors, altering the transmission power used to track the location of the tag can include instructing the tag to alter the transmission power used to identify the location of the tag. For example, the tag may raise or lower the transmission power for a poll response at time t₁ compared to the transmission power for a poll response at time t₀. This adjustment may be based on a pre-programmed sequence, or set randomly by the tag. In various embodiments, when the adjustment is set randomly by the tag, an output from a random number generator is used to determine whether and to what extent to increase or decrease the transmission power at a subsequent polling time relative to the transmission power for the current polling time. In various embodiments, magnitude or level for the transmission power is stored in a variable that is configured to “overflow” or roll-over to ensure that the transmission power set (by sequence or randomly) for the tag remains within the permissible power range for transmissions by the tag.

In some embodiments, the tag may reserve (per instructions from the tracking system) a highest available power level (or the N highest available power levels) for use when exhibiting the zone ambiguity condition. Similarly, in some embodiments, the tag may reserve (per instructions from the tracking system) a lowest available power level (or the N lowest available power levels) for use when exhibiting the zone ambiguity condition. Accordingly, the tracking system may ensure that the tag has one or more power levels to select from when altering the transmission power that were not used using normal operation of the tag (e.g., when not exhibiting the zone ambiguity condition).

Additionally, the tracking system may monitor how long the tag has last experienced a zone ambiguity condition, and instruct the tag to change a power level for tracking signal transmission. Accordingly, the tracking system may move the transmission power off of an otherwise reserved power level (e.g., reserved for use when exhibiting a zone ambiguity condition), and potentially reduce power consumption of the tag when transmitting signals.

When the tracking system and the tag operate in a uni-directional communication mode with the anchors, altering the transmission power used to track the location of the tag can include selecting one or more beacon signals from the tag to use (or ignore) in a given polling interval. In a uni-directional mode, the tag operates without receiving instructions from the tracking system (or the anchors), but transmits a plurality of beacon signals with different power levels across a polling interval. These beacon signals may be sent at the same time (at different frequencies or using multiple antennas with different phases) or at different times over a period of time, and the anchors receive each of the differently powered beacon signals for the tracking system to determine a location for the tag in the polling period. During normal operations (e.g., when the tag is not exhibiting the zone ambiguity condition) the tracking system may use one or more of the received beacon signals to determine the location of the tag. However, when the tag is identified as exhibiting the zone ambiguity condition, the tracking system selects one or more of the beacons signals to use in locating the tag, such that different powers of signals are used during subsequent polling intervals. The selection of different power level signals simulates movement of the tag (with associated differences in signal attenuation from the tag to the anchors) and (when using differently timed transmissions) can enforce time variance among the signals. Accordingly, the tracking system is able to adjust how the location of the tag is tracked without having to instruct the tag to change a transmission power.

FIG. 10 illustrates an example computing device 1000, such as may be used in a location system 100 according to embodiments of the present disclosure. The computing device 1000 includes a processor 1010, such as a central processing unit (CPU) and/or graphics processing unit (GPU), application-specific integrated circuit (ASIC), or the like, communicatively coupled with a non-transitory computer-readable storage medium such as a memory 1020, e.g., a combination of volatile memory elements (e.g., random access memory (RAM)) and non-volatile memory elements (e.g., flash memory or the like). The memory 1020 stores a plurality of computer-readable instructions in the form of applications, including an operating system 1022, and one or more programs 1024 by which the computing device 1000 is instructed to perform various operations when the instructions are executed by the processor 1010, as described herein.

The computing device 1000 also includes a communications interface 1030, enabling the computing device 1000 to establish connections with other computing devices 1000 over various wired and wireless networks. The communications interface 1030 can therefore include any suitable combination of transceivers, antenna elements, and corresponding control hardware enabling communications across a network. The computing device 1000 can include further components (not shown), including output devices such as a display, a speaker, and the like, as well as input devices such as a keypad, a touch screen, a microphone, and the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 8%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
transmitting a poll request to a tag via one or more anchors of a plurality of anchors respectively positioned in a plurality of zones;
receiving poll request responses from at least two anchors of the plurality of anchors when the at least two anchors of the plurality of anchors receive a signal from the tag;
storing the poll request responses received from the at least two anchors to a first queue;
storing a weight for each anchor of the at least two anchors to a second queue;
identifying a zone of the plurality of zones in which the tag is located based on the second queue; and
modifying a transmission signal power of the tag when the tag exhibits a zone ambiguity condition associated with the identified zone and at least one other zone of the plurality of zones in which the tag was previously located.

2. The method of claim 1, wherein when the at least two anchors of the plurality of anchors receive the signal from the tag, each anchor of the at least two anchors:
identifies a tag identification (ID);
determines a set of parameters including a Received Signal Strength Indicator (RSSI), an azimuth of the tag, and an elevation of the tag; and
transmits the tag ID, the set of parameters, and an anchor ID of the given anchor to a tracking system.

3. The method of claim 1, further comprising:
comparing a first anchor ID of a first received poll request response from the tag with a highest anchor ID associated with a highest weight in the second queue; and
incrementing, when the first anchor ID does not match the highest anchor ID, a current jitter counter.

4. The method of claim 3, further comprising:
comparing a second anchor ID of a second received poll request response from the tag after the first anchor ID was received with the highest anchor ID associated with the highest weight in the second queue;
comparing the current jitter counter against a jitter counter threshold when the second anchor ID matches the highest anchor ID and the current jitter counter is not equal to zero;
identifying that the tag exhibits the zone ambiguity condition when the current jitter counter is greater than the jitter counter threshold; and
instructing, in response to identifying the tag exhibiting the zone ambiguity condition, the tag to enable a power diversity mode at the tag through the plurality of anchors.

5. The method of claim 4, wherein the power diversity mode adjusts the transmission signal power of the tag to a different level and the transmission signal power of the tag remains unchanged until a next time the zone ambiguity condition is identified.

6. A method, comprising:
tracking a location of a tag among a plurality of zones via signals transmitted by the tag that are received by one or more anchors of a plurality of anchors, each anchor of the plurality of anchors being associated with a corresponding zone of the plurality of zones, and the tag being tracked as being located in no more than one zone of the plurality of zones at any given time;
identifying that the tag exhibits a zone ambiguity condition; and
modifying, in response to identifying the tag as exhibiting the zone ambiguity condition, a transmission power of the signals used to track the location of the tag until the tag no longer exhibits the zone ambiguity condition.

7. The method of claim 6, wherein identifying the tag as exhibiting the zone ambiguity condition comprises:
storing an anchor identification (ID) of each anchor of the plurality of anchors and a Received Signal Strength Indicator (RSSI) for the signals as received by each anchor of the plurality of anchors from the tag to fill a first queue;
weighting the first queue based on a number of entries for each anchor of the plurality of anchors in the first queue and associated RSSIs thereof to generate a weight for each anchor of the plurality of anchors in a second queue; and
tracking, based on a current jitter counter value relative to a threshold, whether the tag is non-consecutively associated with a queued anchor of the plurality of anchors with a highest weight in the second queue.

8. The method of claim 7, wherein tracking whether the tag is non-consecutively associated with the queued anchor further comprises:
comparing a first anchor ID of a first received poll request response from the tag with a highest anchor ID associated with a highest weight in the second queue;
incrementing, when the first anchor ID does not match the highest anchor ID, a current jitter counter;
comparing a second anchor ID of a second received poll request response from the tag after the first anchor ID was received with the highest anchor ID associated with the highest weight in the second queue; and
comparing the current jitter counter against the threshold when the second anchor ID matches the highest anchor ID and the current jitter counter is not equal to zero.

9. The method of claim 6, wherein modifying the transmission power of the signals used to track the location of the tag further comprises, when the tag operates in a bi-directional communication mode with the plurality of anchors:
instructing the tag to modify, based on an output of a random number generator, the transmission power at a subsequent polling time to be one of higher than or lower than the transmission power at a current polling time.

10. The method of claim 6, wherein modifying the transmission power of the signals used to track the location of the tag further comprises, when the tag operates in a uni-directional communication mode with the plurality of anchors:
receiving a plurality of beacon signals from the tag with different power levels in response to a polling interval occurring; and
selecting a given beacon signal from the plurality of beacon signals for a current polling time with a different power level than a previously selected beacon signal for a previous polling time.

11. The method of claim 6, further comprising:
tracking a duration that the tag exhibits the zone ambiguity condition; and
transmitting, in response to the duration satisfying a threshold, an alert to a device associated with the tag.

12. The method of claim 6, further comprising:
instructing the tag to reserve use of a highest available transmission power level when exhibiting the zone ambiguity condition.

13. The method of claim 6, further comprising:
tracking a duration that the tag does not exhibit the zone ambiguity condition; and
transmitting, in response to the duration satisfying a threshold, an instruction to the tag to reduce the transmission power.

14. A system, comprising:
a processor; and
a memory storing instructions that, when executed by the processor, perform operations including:
tracking a location of a tag among a plurality of zones via signals transmitted by the tag that are received by one or more anchors of a plurality of anchors, each anchor of the plurality of anchors being associated with a corresponding zone of the plurality of zones, and the tag is tracked as being located in no more than one zone of the plurality of zones at any given time;
identifying that the tag exhibits a zone ambiguity condition; and
modifying, in response to identifying the tag as exhibiting the zone ambiguity condition, a transmission power of the signals used to track the location of the tag until the tag no longer exhibits the zone ambiguity condition.

15. The system of claim 14, wherein identifying the tag as exhibiting the zone ambiguity condition comprises:
storing an anchor identification (ID) of each anchor of the plurality of anchors and a Received Signal Strength Indicator (RSSI) for the signals as received by each anchor of the plurality of anchors from the tag to fill a first queue;
weighting the first queue based on a number of entries for each anchor of the plurality of anchors in the first queue to generate a weight for each anchor of the plurality of anchors in a second queue; and
tracking, based on a current jitter counter value relative to a threshold, whether the tag is non-consecutively associated with a queued anchor of the plurality of anchors with a highest weight in the second queue.

16. The system of claim 15, wherein tracking whether the tag is non-consecutively associated with the queued anchor further comprises:
comparing a first anchor ID of a first received poll request response from the tag with a highest anchor ID associated with a highest weight in the second queue;
incrementing, when the first anchor ID does not match the highest anchor ID, a current jitter counter;
comparing a second anchor ID of a second received poll request response from the tag after the first anchor ID was received with the highest anchor ID associated with the highest weight in the second queue; and
comparing the current jitter counter against the threshold when the second anchor ID matches the highest anchor ID and the current jitter counter is not equal to zero.

17. The system of claim 14, wherein altering the transmission power of the signals used to track the location of the tag further comprises, when the tag operates in a bi-directional communication mode with the plurality of anchors:
instructing the tag, based on an output of a random number generator, to modify the transmission power at a subsequent polling time to be one of higher than or lower than the transmission power at a current polling time.

18. The system of claim 14, wherein modifying the transmission power of the signals used to track the location of the tag further comprises, when the tag operates in a uni-directional communication mode with the plurality of anchors:
receiving a plurality of beacon signals from the tag with different power levels in response to a polling interval occurring; and
selecting a given beacon signal from the plurality of beacon signals for a current polling time with a different power level than a previously selected beacon signal for a previous polling time.

19. The system of claim 14, the operations further comprising:
tracking a duration that the tag exhibits the zone ambiguity condition; and
transmitting, in response to the duration satisfying a threshold, an alert to a supervisory device associated with the tag.

20. The system of claim 14, the operations further comprising:
instructing the tag to reserve use of a highest available transmission power level when exhibiting the zone ambiguity condition.
